(19) United States
(12) Patent Application Publication
(10) Pub. No.: US 2020/0084024 A1
(43) Pub. Date: Mar. 12, 2020

(54) One Time Pad Cryptography Method and Apparatus

(71) Applicant: Jeffrey Van MYERS, Driftwood, TX (US)

(72) Inventor: Jeffrey Van MYERS, Driftwood, TX (US)

(21) Appl. No.: 15/942,514

(22) Filed: Mar. 31, 2018

(51) Int. Cl. H04L 9/06; H04L 29/06; H04L 9/16

(52) U.S. Cl. CPC H04L 9/0656; H04L 9/16; H04L 63/18; H04L 63/0428

(57) ABSTRACT

A communication system comprising a server device and a client device connected via a public network. The server generates a one time pad (“OTP”) comprising a plurality of mutually random keys, and pre-shares the OTP with the client via a secure communication channel instantiated on the public network. Thereafter, each time the client transmits a packet of a message, the client encrypts that packet with the “top” key in the client's local copy of the OTP; and, upon receipt, the server decrypts the encrypted packet using the same “top” key in the server's local copy of the OTP. Both the client and server then delete the now-used key from the OTP, thereby creating a new “top” key in both local copies of the OTP. This key consumption process continues until all packets have been securely transmitted.

### BACKGROUND OF THE INVENTION

### 1. Field of the Invention

The present invention relates to methods and apparatus for encrypting and decrypting messages transmitted over a public communication network.

### 2. Description of the Related Art

In general, in the descriptions that follow, I will italicize the first occurrence of each special term of art that should be familiar to those skilled in the art of integrated circuits (“ICs”) and systems. In addition, when I first introduce a term that I believe to be new or that I will use in a context that I believe to be new, I will bold the term and provide the definition that I intend to apply to that term. In addition, throughout this description, I will sometimes use the terms assert and negate when referring to the rendering of a signal, signal flag, status bit, or similar apparatus into its logically true or logically false state, respectively, and the term toggle to indicate the logical inversion of a signal from one logical state to the other. Alternatively, I may refer to the mutually exclusive boolean states as logic_0 and logic_1. Of course, as is well known, consistent system operation can be obtained by reversing the logic sense of all such signals, such that signals described herein as logically true become logically false and vice versa. Furthermore, it is of no relevance in such systems which specific voltage levels are selected to represent each of the logic states.

Hereinafter, when I refer to a facility I mean a circuit or an associated set of circuits adapted to perform a particular function regardless of the physical layout of an embodiment thereof. Thus, the electronic elements comprising a given facility may be instantiated in the form of a hard macro adapted to be placed as a physically contiguous module, or in the form of a soft macro the elements of which may be distributed in any appropriate way that meets speed path requirements. In general, electronic systems comprise many different types of facilities, each adapted to perform specific functions in accordance with the intended capabilities of each system. Depending on the intended system application, the several facilities comprising the hardware platform may be integrated onto a single IC, or distributed across multiple ICs. Depending on cost and other known considerations, the electronic components, including the facility-instantiating IC(s), may be embodied in one or more single- or multi-chip packages. However, unless I expressly state to the contrary, I consider the form of instantiation of any facility that practices my invention as being purely a matter of design choice.

Shown in FIG. 1 is a typical eMail communication system 10. In one embodiment, the system 10 comprises an eMail Server facility 12, having a local database (“DB”) facility 14, and an eMail Client facility 16, having a local DB facility 18. In the illustrated embodiment, Server 12 and Client 16 connected via an interconnection network 20. For the purpose of this application, I will assume that the network 20 comprises one or more wired or wireless channels, at least some of which are accessible by the public. In general, the operation of the eMail communication system 10 is well known in the art.

Shown in FIG. 2 is a typical computer processing system 22 adapted to perform the functions of both the Server 12 and the Client 16. In general, the several functional facilities comprising processing system 22 are well known in the art. Typical embodiments can be obtained commercially from various suppliers, e.g., Hewlett-Packard Development Company, L.P., Dell, Inc., Apple Inc., and the like.

In the past, various attempts have been made to protect messages from eavesdropping or modification by unauthorized persons while in transit over a public communication network. In the field of cryptography, many encryption protocols have been proposed to solve this problem. One such system, known as secure shell (“ssh”), has come into very widespread use for traffic transmitted over the Internet. One other popular approach, known as public key cryptography, has proven especially useful when implemented in the context of a public key infrastructure (“PKI”). However, while generally considered satisfactory for some types of traffic, both ssh and PKI impose substantial computational loads on the end points, as well as significant non-data-related network traffic. More importantly, both of these techniques suffer from inherent cryptographic weaknesses.

As has been known for many years by cryptographers, the only encryption technique that cannot be cracked is the so-called one-time pad (“OTP”). In accordance with the traditional form of this technique, each encryption key in the OTP is constructed so as to be at least as long as a message to be encrypted. The OTP is then pre-shared via a trusted exchange mechanism between a sender and a recipient. In the encryption process, the sender encrypts each bit or character of a plaintext message by combining it with the corresponding bit or character from a particular page of the OTP; upon being received, the recipient decrypts each bit or character of the received cyphertext by reversing the combination process using the respective page of the OTP. The most problematic aspect of the OTP technique is the difficulty of securely pre-sharing the OTP. This process is described in detail in a number of well-known publications, including, inter alia, The Code Book, by Simon Singh, Anchor Books (2000), express incorporation of the entirety of which is hereby made by reference.

In the field of cryptography, the OTP is considered to be an early implementation of what are now referred to as ephemeral keys. In general, a cryptographic key is referred to as ephemeral if it is generated for each execution of a key establishment process. Various mechanisms have been proposed for controlling the consumption sequence of these keys. For the purposes of the following description, I hereby define “consumption sequence” to mean the sequence in which the keys comprising the OTP are first used to encrypt/decrypt a message packet, and, thereafter, consumed, i.e., deleted, on a packet-by-packet basis, by the sender and recipient from the respective local copies of the OTP, whereby what was the “second” key in the OTP before consumption of the current “first” key automatically becomes the next “first” key. One example in the prior art is known as ratcheting. One embodiment of racheting is discussed in the eDocument, “Advanced cryptographic ratcheting”, that I downloaded 1 Jan. 2018 from https://signal. org/blog/advanced-ratcheting/. Another ratcheting algorithm is disclosed in a Wiki-Document that may be found at https://en.wikipedia.org/wiki/Double_Ratchet_Algorithm. Yet another prior art key management protocol is discussed in “Off-the-Record Messaging Protocol version 3”, that I downloaded on 1 Jan. 2018 from https://otr.cypherpunks.ca/Protocol-v3-4.0.0.html. I have submitted herewith a copy of each of these prior art eDocuments, and hereby expressly incorporate each herein, in its entirety, by reference. However, I am aware of no prior art consumption sequencing methodology that is not inherently computationally complex.

Thus, I submit, the essential missing piece of this puzzle is a simple, but secure, method for exchanging ephemeral keys, and, thereafter, for securely coordinating the consumption sequence of the keys by the sender and recipient. I submit that what is needed is a one time pad cryptography method and apparatus that is more secure, efficient and effective than the known cryptographic art.

### BRIEF SUMMARY OF THE INVENTION

In accordance with one embodiment of my invention, I provide a one time pad (OTP) cryptography method adapted for use in a public communication system comprising: a public communication network; a first communication facility adapted to be selectively coupled to the public communication network; and a second communication facility adapted to be selectively coupled to the public communication network. In one embodiment, my method comprises the steps of: first, in a selected one of the first and second communication facilities, developing a OTP comprising at least a first key; and then using a secure channel instantiated on the public communication network to pre-share the OTP with the first and second communication facilities; second, in the first communication facility: using the first key to encrypt a first packet of a first message comprising a plurality of packets; and then transmitting the encrypted first packet via a non-secure channel instantiated on the public communication network; third, in the second communication facility: receiving the encrypted first packet via the non-secure channel; and then using the first key to decrypt the encrypted first packet; and, fourth, in the first and second communication facilities, consuming the first key.

In accordance with one other embodiment of my invention, I provide a one time pad (OTP) cryptography method adapted for use in a system comprising: a public communication network; a first computational facility selectively coupled to the communication network; and a second computational facility selectively coupled to the communication network. In this embodiment, my method comprises: an OTP initialization phase comprising the steps of: in a selected one of the first and second computational facilities, generating an OTP comprising a first random key and a second random key; opening a secure communication channel between the selected computational facility and the non-selected computational facility via the public communication network; selectively transmitting the OTP from the selected computational facility to the non-selected computational facility via the secure communication channel; and closing the secure communication channel; and an OTP consumption phase comprising the steps of: opening a non-secure communication channel between the first and second computational facilities via the public communication network; in the first and second computational facility, selecting the first random key from the OTP; in the first computational facility, using the selected first random key to encrypt a first packet of a first message in the first computational facility, transmitting the encrypted first packet to the second computational facility; in the second computational facility, receiving the encrypted first packet from the first computational facility; in the second computational facility, using the selected first random key to decrypt the received encrypted first packet; in the first and second computational facilities, consuming the first random key from the OTP whereby the second random key is now the first random key in the OTP; if the transmitted packet is not the last packet of the first message, repeating a selected subset of the above steps; and, otherwise, closing the non-secure communication channel.

In accordance with yet another embodiment of my invention, a communication system may be configured to practice my methods.

In accordance with still another embodiment of my invention, a non-transitory computer readable medium may include executable instructions which, when executed in a processing system, causes the processing system to perform the steps of my one time pad encryption methods.

### BRIEF DESCRIPTION OF THE SEVERAL VIEWS OF THE DRAWINGS

My invention may be more fully understood by a description of certain preferred embodiments in conjunction with the attached drawings in which:

FIG. 1 illustrates, in block diagram form, a communication system adapted to practice my invention;

FIG. 2 illustrates, in block diagram form, a typical server facility adapted to practice my invention;

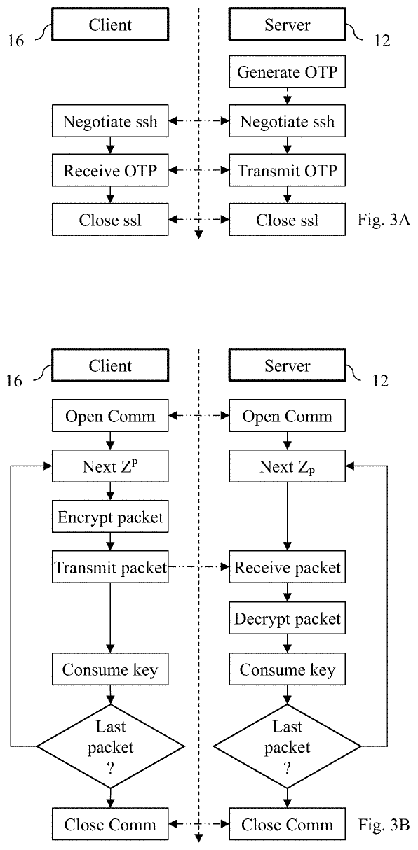

FIG. 3, comprising FIG. 3A and FIG. 3B, illustrates, in parallel flow diagram form, one embodiment of my Implicit Sequencing Process;

FIG. 4, comprising FIG. 4A and FIG. 4B, illustrates, in parallel flow diagram form, one embodiment of my Direct Sequencing Process;

FIG. 5, comprising FIG. 5A and FIG. 5B, illustrates, in parallel flow diagram form, one embodiment of my Indexed Sequencing Process; and

FIG. 6, comprising FIG. 6A and FIG. 6B, illustrates, in parallel flow diagram form, one embodiment of my Express Sequencing Process; and

FIG. 7 illustrates, in block diagram form, another communication system adapted to practice my invention.

In the drawings, similar elements will be similarly numbered whenever possible. However, this practice is simply for convenience of reference and to avoid unnecessary proliferation of numbers, and is not intended to imply or suggest that my invention requires identity in either function or structure in the several embodiments.

### DETAILED DESCRIPTION OF THE INVENTION

From time to time, by way of example, I will provide code snippets to illustrate processor-implementable techniques adapted to perform certain aspects of my methods. Unless otherwise noted, these snippets will be composed in the well-known PHP Hypertext Preprocessing (“PHP”) language. In accordance with the PHP language standard:

lines of PHP code are enclosed between an open group, “<?php”, and a close group, “?>”;

variable names start with a dollar sign, “$”; and

comments are separated from code by the double-slash, “//”.

In accordance with my preferred programming standards, the data types of the several variables will be denoted by the first alphabetic character following the $ sign as follows:

a=>array;

b=>boolean;

f=>floating point;

i=>integer;

o=>object;

r=>resource; and

s=>string.

In some of my example snippets, accesses will be made by Server 12 to DB 14, which I have chosen to implement using the popular, open source MySQL database server. In each of these queries, the syntax and semantics will conform to the published MySQL language standard.

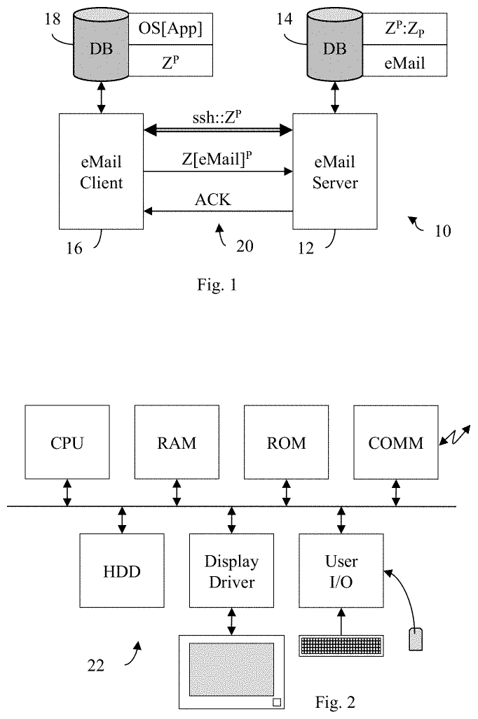

In the embodiment of FIG. 1, I have illustrated what I characterize as a direct communication system adapted to provide end-to-end encryption of all packets containing confidential data transmitted to Server 12 by Client 16. In particular, I characterize this approach as an Implicit Sequencing Process in that, in this approach: the OTP comprises actual keys; and the order of keys in the OTP implicitly controls the consumption sequence of those keys.

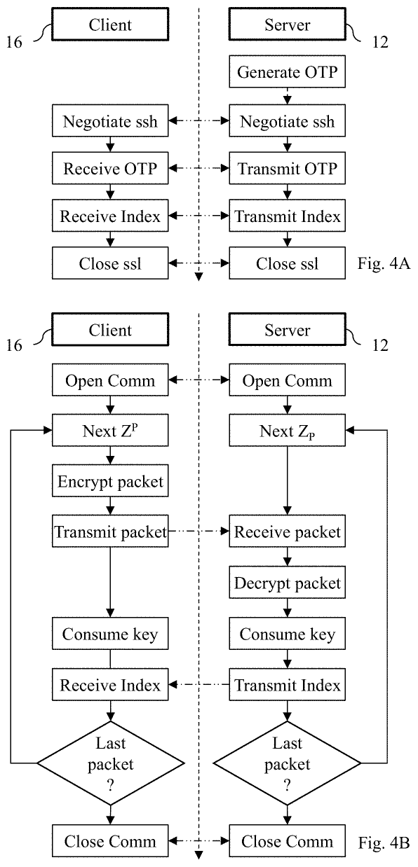

Shown in FIG. 3A is one embodiment of the Initialization Phase of my Implicit Sequencing Process, to be first executed during system boot. First, Server 12 generates an OTP, comprising an enumerated plurality, Z, of public-private key_pairs, each key_pair comprising a public key, Z^{P} and a private key, Z_{P}. For example, let us assume that Z comprises 1024 key_pairs generated using the following PHP code snippet:

<?php
// Generate a new keys table
$aConfig = array // openssl pkey parameters
(

“digest_alg” => “sha512”,
“private_key_bits” => 2048,
“private_key_type” => OPENSSL_KEYTYPE_RSA

);
$iMaxKeys = 1024; // total number of key_pairs in Z
$iKeys = 0; // initialize key counter
do
{

$rKeyPair = openssl_pkey_new($aConfig); // generate key_pair
$aPublicKey = openssl_pkey_get_details($rKeyPair); // get public key details
$sPublicKey = $aPublicKey[‘key’]; // get public key
openssl_pkey_export($rKeyPair, $sPrivateKey); // get private key
if (!Encryption::_publicKeyExists($sPublicKey)) // accept if unique
{

Encryption::addKeyPair($sPublicKey, $sPrivateKey) // add key_pair
++$iKeys; // increment key counter

}

} while ($iKeys < $iMaxKeys);
?>

In this OTP-generation snippet, I have made calls to two different functions contained within a PHP class named “Encryption”. By way of example, the protected class function “_publicKeyExists” may be implemented as follows:

<?php
// Check to see if sPublicKey already exists in the keys table
protected static function _publicKeyExists($sPublicKey = ‘’)
{

if (!$sPublicKey)
{

logError(‘_publicKeyExists 1: got no sPublicKey’);
return false;

}
$sql = ‘SELECT COUNT(*)

FROM DB.keys
WHERE key_public = \“.$sPublicKey.’\”;

$oTmp = $oMySQL−>query($sql);
if (is_array($oTmp))
{

logError(‘_publicKeyExists 2: access to DB failed’);
return false;

}
$iCnt = (int) $oMySQL−>fetchOne($oTmp);
return $iCnt;

} // end function _publicKeyExists
?>

wherein the “(int)” expressly constrains to an integer the returned random number. Further, by way of example, the public class function “addKeyPair” may be implemented as follows:

<?php
// Add a new key_pair to the akeys table
public static function addKeyPair($sPublicKey = “, $sPrivateKey = ”)
{

if (!$sPublicKey)
{

logError(‘addKeyPair 1: got no sPublicKey’);
return false;

}
if (!$sPrivateKey )
{

logError(′addKeyPair 2: got no sPrivateKey );
return false;

}
$sql = ‘INSERT INTO DB.akeys

```
(
  akey_public,
  akey_private,
  akey_created_dt
)
```

VALUES

```
(
  \“.$sPublicKey.’\”,
  \“.$sPublicKey.’\”,
  (NOW( ))
)’;
```

$oTmp = $oMySQL−>query($sql);
if (is_array($oTmp))
{

logError(‘addKeyPair 3: access to DB failed’);
return false;

}
return true;

} // end function addKeyPair
?>

In support of the functions described above, I have created the keys table in the DB 14 associated with Server 12 according to the following MySQL table definition:

```
CREATE TABLE ‘akeys‘
(
  ‘akey_index‘ int(10) unsigned NOT NULL AUTO_INCREMENT,
  ‘akey_public‘ text NOT NULL,
  ‘akey_private‘ text NOT NULL,
  ‘akey_created_dt‘ datetime NOT NULL,
  PRIMARY KEY (‘akey_index‘)
) ENGINE=InnoDB DEFAULT CHARSET=utf8;
```

wherein:
the field ‘akey-id’ comprises the index of each key_pair;
the field ‘akey-public’ comprises the public key field;
the field ‘akey-private’ comprises the private key field;
the field akey_df comprises the datetime the key_pair was created;
the InnoDB is the particular MySQL ENGINE I have selected; and

the DEFAULT CHARSET I have selected is utf8.

In anticipation of opening the first ssl session with Client 16, Server 12 can retrieve from DB 14 the OTP as follows:

<?php
// Get the OTP from the DB
$sZ = ‘’; // start the public key string
$aZ = Encryption::getPublicKeys( ); // retrieve the public keys
foreach($aZ as $aCodes)
{

$sZ .= ‘:’.$aCodes[‘akey_public’]; // append to public key string

}
?>

wherein:
the periods “.” invoke the PHP string concatenate function; and
the “‘:’.” sequence inserts a colon “:” between each string element.

In this OTP-retrieval snippet, I have made a call to one additional new function contained within my Encryption class. By way of example, the public class function “getPublicKeys” may be implemented as follows:

<?php
// Get only the public keys from the keys table
public static function getPublicKeys( )
{

$sql = ‘SELECT akey_index, akey_public

FROM DB.akeys
ORDER BY akey_index;

$oTmp = $oMySQL−>query($sql);
if (is_array($oTmp))
{

logError(‘getPublicKeys 1: access to DB failed’);
return false;

}
if ($oTmp−>num_rows < 1)
{

logError(‘getPublicKeys 2: got no data’);
return false;

}
while ($aKey = $oMySQL−>fetchRow($oTmp,
FETCHMODE_ASSOC))
{

$iKeyId = $aKey[‘akey_index’];
$aKeys[$iKeyId] = $aKey[‘akey_public’];

}
return $aKeys;

} // end function getPublicKeys
?>

After negotiating an ssh session, Server 12 transmits to Client 16 the OTP. Thus, at the end of this Initialization Phase, both Server 12 and Client 16 share a common OTP.

Shown in FIG. 3B is one embodiment of the Consumption Phase of my Implicit Sequencing Process, to be performed each time Client 16 desires to transmit a packet to Server 12. After opening a public, i.e., un-secure, communication (“Comm”) channel between Client 16 and Server 12, both Client 16 and Server 12 select the first/next key, sequentially, in the OTP, wherein the key selected by Client 16 is a public key, Z^{P}, and the key selected by Server 12 is the respective private key, Z_{P}. Client 16 then uses the selected Z^{P} to encrypt the first/next packet in the message protocol for transmission to Server 12. Upon receipt, Server 12 uses the selected Z_{P} to decrypt the received packet. Both Client 16 and Server 12 then consume the now-used key_pair, i.e., each deletes the respective keys from the local copies of the OTP. This process loops until the last packet of the message has been transmitted, whereupon the comm channel is closed. Note that this communication channel need be neither secure nor trusted, since all packets transiting the channel will be encrypted.

My Implicit Sequencing Process may be re-executed at any time following boot. In particular, when the number of remaining key_pairs in the local OTP falls below a selected threshold, Server 12 can re-execute the Initialization Phase to generate a new OTP for ssh transmission to Client 16 shortly before, or contemporaneous with, the mutual exhaustion of the previous OTP. Thus, just as in a traditional paper OTP process, each key_pair comprising my electronic OTP is used once and only once.

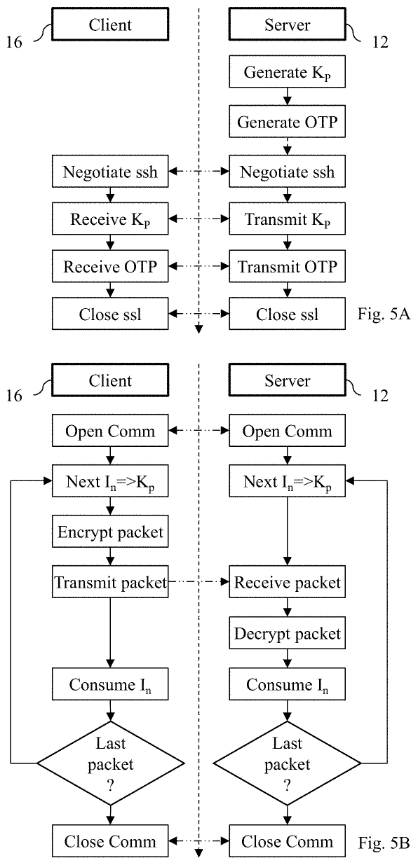

Shown in FIG. 4A is one embodiment of the Initialization Phase of my Direct Sequencing Process, to be first executed during system boot. Just as in the Initialization Phase of my Implicit Sequencing Process, Server 12 generates an OTP, comprising an enumerated plurality, Z, of public-private key_pairs, each pair comprising a public key, Z^{P} and a private key, Z_{P}. For this example, let us assume that Z is generated by Server 12 and transmitted to Client 16 using the code snippets discussed above. However, in this embodiment, after transmitting the OTP, Server 12 randomly selects the index one of the key_pairs in the OTP using the following PHP code snippet:

<?php
// Randomly select a new index
$iMaxIndicies = 1024; // total number of indicies in OTP
$bOK = false;
do
{

$iIndex = (int) mt_rand (1, $iMaxIndicies )]; // generate a new index
if (Encryption::_publicKeyExists($iIndex )) // accept if still in OTP
{

Encryption::deletePublicKey($iIndex ) // delete akey at iIndex
$bOK = true; // exit do loop

}

} while (!$bOK)
?>

In this OTP-generation snippet, I have made a call to the _publicKeyExists function, described above, and a call to a new function contained within my Encryption class. By way of example, the public class function “deletePublicKey” may be implemented as follows:

<?php
// Delete the key_pair at iIndex from the akeys table
protected static function deletePublicKey($iIndex = 0)
{

if (!$iIndex )
{

logError(deleteIndex 1: got no iIndex );
return false;

}
$sql = ‘DELETE FROM DB.akeys

WHERE akey_index = \“.$iIndex.’\”;

$oTmp = $oMySQL−>query($sql);
if (is_array($oTmp))
{

logError(deleteIndex 2: access to DB failed’);
return false;

}
return true;

} // end function deletePublicKey
?>

Thus, during the Initialization Phase of my Direct Sequencing Process, Server 12 directs Client 16 to use the Z^{P} associated in the OTP with the transmitted index for encrypting the first packet of the next transmitted message.

Shown in FIG. 4B is one embodiment of the Consumption Phase of my Direct Sequencing Process, to be performed each time Client 16 desires to transmit a packet to Server 12. As can be seen by comparing the flow illustrated in FIG. 4B to the flow in FIG. 3B, the Consumption Phase of my Direct Sequencing Process differs from the Consumption Phase of my Implicit Sequencing Process primarily in the mechanism I use to control the selection of the next sequential key_pair in the respective OTPs. In this flow, after Client 16 and Server 12 consume the just-used key_pair, Server 12 will randomly select (using the same code snippets described above) the index of the key_pair in the OTP to be used to encrypt/decrypt the next packet. Note that, if the last packet of the current message has just been transmitted, the key_pair having this index will be used to encrypt/decrypt the first packet of the next message to be transmitted.

My Direct Sequencing Process may be re-executed at any time following boot. In particular, when the number of remaining key_pairs in the local OTP falls below a selected threshold, Server 12 can re-execute the Initialization Phase to generate a new OTP for ssh transmission to Client 16 shortly before, or contemporaneous with, the mutual exhaustion of the previous OTP. Again, just as in a traditional paper OTP process, each key_pair comprising my electronic OTP is used once and only once.

As is known, asymmetric cryptography, of which the public key technology is one example, is substantially more computationally complex than symmetric cryptography. However, it has been proved that asymmetric cryptography is more resistant to cracking than symmetric cryptography. As a result, asymmetric cryptography techniques are often used to create a secure channel for transmitting symmetric cryptographic keys, with the balance of the message thereafter being encrypted using symmetric techniques. Since ssh uses public key cryptographic techniques during ssh sessions, I consider it safe to populate my OTPs with symmetric keys, thereby realizing the benefit of significantly reduced computational complexity in both of Client 16 and Server 12. Except for this difference, the flows of such embodiments will be substantially the same as those discussed above. For example, let us assume that Z now comprises 1024 symmetric keys generated using the following PHP code snippet:

<?php
// Generate a new symmetric keys table
$iMaxKeys = 1024; // total number of key_pairs in Z
$iKeys = 0; // initialize key counter
do
{

$sKey = openssl_random_pseudo_bytes(256); // generate random 256 bytes
if (!Encryption::_KeyExists($sKey)) // accept if unique
{

Encryption::addKey($sKey, $sKey) // add key
++$iKeys; // increment key counter

}

} while ($iKeys < $iMaxKeys);
?>

In this OTP-generation snippet, I have made calls to two new functions contained within my Encryption class. By way of example, the protected class function “_KeyExists” may be implemented as follows:

<?php
// Check to see if sKey already exists in the symmetric keys table
protected static function _KeyExists($sKey = ‘’)
{

if (!$sKey)
{

logError(‘_KeyExists 1: got no sKey’);
return false;

}
$sql = ‘SELECT COUNT(*)

FROM DB.skeys
WHERE skey_key = \“.$sKey.’\”;

$oTmp = $oMySQL−>query($sql);
if (is_array($oTmp))
{

logError(‘_KeyExists 2: access to DB failed’);
return false;

}
$iCnt = (int) $oMySQL−>fetchOne($oTmp);
return $iCnt;

} // end function_KeyExists
?>

Further, by way of example, the public class function “addKey” may be implemented as follows:

<?php
// Add a new key_pair to the symmetric keys table
public static function addKey($sKey = ‘’)
{

if (!$sKey)
{

logError(‘addKey 1: got no sKey’);
return false;

}
$sql = ‘INSERT INTO DB.skeys

```
(
  skey_key,
  skey_created_dt
)
```

VALUES

```
(
  \“.$sKey.’\”,
  (NOW( ))
)’;
```

$oTmp = $oMySQL−>query($sql);
if (is_array($oTmp))
{

logError(‘addKey 2: access to DB failed’);
return false;

}
return true;

} // end function addKey
?>

In support of the functions described above, I have created the symmetric keys table in DB 14 associated with Server 12 according to the following My SQL table definition:

```
CREATE TABLE ‘skeys‘
(
  ‘skey_id‘ int(10) unsigned NOT NULL AUTO_INCREMENT,
  ‘skey_key‘ text NOT NULL,
  ‘skey_created_dt‘ datetime NOT NULL,
  PRIMARY KEY (‘skey_index‘)
) ENGINE=InnoDB DEFAULT CHARSET=utf8;
```

wherein:
the field ‘skey-id’ comprises the index of each key;
the field ‘skey-key’ comprises the key text field;
the field ‘key_dt’ comprises the datetime the key was created;
the InnoDB is the particular MySQL ENGINE I have selected; and
the DEFAULT CHARSET I have selected is utf8.

In anticipation of opening the first ssl session with Client 16, Server 12 can retrieve from DB 14 the OTP as follows:

<?php
// Get the OTP from the DB
$sZ = ‘’; // start the symmetric key string
$aZ = Encryption::getKeys( ); // retrieve the symmetric keys
foreach($aZ as $aCodes)
{

$sZ .= ‘:’.$aCodes[‘skey_key’]; // append to symmetric key string

}
?>

In this OTP-retrieval snippet, I have made a call to one additional new function contained within my Encryption class. By way of example, the public class function “getKeys” may be implemented as follows:

<?php
// Get only the symmetric keys from the keys table
public static function getKeys( )
{

$sql = ‘SELECT skey_index, skey_key

FROM DB.skeys
ORDER BY skey_index;

$oTmp = $oMySQL−>query($sql);
if (is_array($oTmp))
{

logError(‘getKeys 1: access to DB failed’);
return false;

}
if ($oTmp−>num_rows < 1)
{

logError(‘getKeys 2: got no data’);
return false;

}
while ($aKey = $oMySQL−>fetchRow($oTmp, FETCHMODE_ASSOC))
{

$iKeyId = $aKey[‘skey_index’];
$aKeys[$iKeyId] = $aKey[‘skey_public’];

}
return $aKeys;

} // end function getKeys
?>

In this symmetric key example, the sequencing of indices is the same as in my asymmetric example. However, the public class function “deleteIndex” should be implemented as follows:

<?php
// Delete the key at iIndex from the symmetric keys table
protected static function deleteIndex($iIndex = 0)
{

if (!$iIndex )
{

logError(deleteIndex 1: got no iIndex );
return false;

}
$sql = ‘DELETE FROM DB.skeys

WHERE skey_index = \“.$iIndex.’\”;

$oTmp = $oMySQL−>query($sql);
if (is_array($oTmp))
{

logError(deleteIndex 2: access to DB failed’);
return false;

}
return true;

} // end function deleteIndex
?>

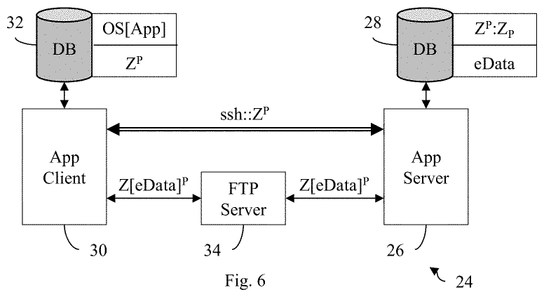

Shown in FIG. 5A is one embodiment of the Initialization Phase of my Indexed Sequencing Process, to be first executed during system boot. In the Initialization Phase of my Indexed Sequencing Process, Server 12 generates a keys table, K, comprising an enumerated plurality, P, of symmetric keys, Kₚ. For this example, let us assume that K is generated by Server 12 and transmitted to Client 16 using the code snippets discussed above. However, in this embodiment, Server 12 generates the OTP such that it comprises a plurality, N, of unique indicies, I, into K, using, for example, the following:

<?php
// Generate a new index table
$iMaxIndexs = 512; // total number of indexs in I
$iIndexs = 0; // initialize index counter
do
{

$iIndex = (int) mt_rand (1, $iMaxIndicies )]; // generate a new index
if (!Encryption::_indexExists($iIndex )) // accept if not already in OTP
{

Encryption::addIndex($iIndex) // add index
++$iIndexs ; // increment index counter

}

} while ($iIndexs < $iMaxIndexs );
?>

In this OTP-generation snippet, I have made calls to two new functions contained within my Encryption class. By way of example, the protected class function “_indexExists” may be implemented as follows:

<?php
// Check to see if iIndex already exists in the index table
protected static function _indexExists($iIndex = 0)
{

if (!$iIndex )
{

logError(‘_indexExists 1: got no iIndex );
return false;

}
$sql = ‘SELECT COUNT(*)

FROM DB.index
WHERE index_index = \“.$iIndex .’\”;

$oTmp = $oMySQL−>query($sql);
if (is_array($oTmp))
{

logError(‘_indexExists 2: access to DB failed’);
return false;

}
$iCnt = (int) $oMySQL−>fetchOne($oTmp);
return $iCnt;

} // end function _indexExists
?>

Further, by way of example, the public class function “addIndex” may be implemented as follows:

<?php
// Add a new index to the index table
public static function addIndex($iIndex = 0)
{

if (!$iIndex )
{

logError(addIndex 1: got no iIndex );
return false;

}
$sql = ‘INSERT INTO DB.index

(
index_index
)

VALUES

(
\“.$iIndex .’\”
)’;

$oTmp = $oMySQL−>query($sql);
if (is_array($oTmp))
{

logError(addIndex 2: access to DB failed’);
return false;

}
return true;

} // end function addIndex
?>

In support of the functions described above, I have created the index table in DB 14 associated with Server 12 according to the following MySQL table definition:

```
CREATE TABLE ‘index‘
(
  ‘index_id‘ int(10) unsigned NOT NULL AUTO_INCREMENT,
  ‘index_index‘ int(10) NOT NULL
  PRIMARY KEY (‘index_id‘),
  KEY ‘index_index‘ (‘index_index‘)
) ENGINE=InnoDB DEFAULT CHARSET=utf8;
```

wherein:
   the field ‘index-id’ comprises the index of each index;
   the field ‘index-index’ comprises the index field;
   the InnoDB is the particular MySQL ENGINE I have selected; and
   the DEFAULT CHARSET I have selected is utf8.
Note that I did not include a datetime field since I consider indexes to be transitory, i.e., time insensitive, but this is certainly a matter of choice. Note also that I instructed the MySQL server to create a second index based on the ‘index_index’ field, thereby to speed up the deleteIndex function, described below.

In anticipation of opening the first ssl session with Client 16, Server 12 can retrieve from DB 14 the OTP as follows:

<?php
// Get the OTP from the DB
$sI = ‘’; // start the index string
$aI = Encryption::getIndexes( ); // retrieve the indexes
foreach($aI as $aIndexes)
{

$sI .= ‘:’.$aIndexes[‘index_index’]; // append to index string

}
?>

In this OTP-retrieval snippet, I have made a call to one additional new function contained within my Encryption class. By way of example, the public class function “getIndexes” may be implemented as follows:

<?php
// Get all of the indexes from the index table
public static function getIndexes( )
{

$sql = ‘SELECT index_id, index_index

FROM DB.index
ORDER BY index_id;

$oTmp = $oMySQL−>query($sql);
if (is_array($oTmp))
{

logError(getIndexes 1: access to DB failed’);
return false;

}
if ($oTmp−>num_rows < 1)
{

logError(getIndexes 2: got no data’);
return false;

}
while ($aIndex = $oMySQL−>fetchRow($oTmp, FETCHMODE_ASSOC))
{

$iIndexId = $aIndex [‘index_id’];
$aIndexes[$iIndexId] = $aIndex [‘index_index’];

}
return $aIndexes;

} // end function getIndexes
?>

In this example, the public class function “deleteIndex” should be implemented as follows:

<?php
// Delete the key at iIndex from the index table
protected static function deleteIndex($iIndex = 0)
{

if (!$iIndex )
{

logError(deleteIndex 1: got no iIndex );
return false;

}
$sql = ‘DELETE FROM DB.index

WHERE index_index = \“.$iIndex.’\”;

$oTmp = $oMySQL−>query($sql);
if (is_array($oTmp))
{

logError(deleteIndex 2: access to DB failed’);
return false;

}
return true;

} // end function deleteIndex
?>

Thus, during the Initialization Phase, Server 12 pre-shares with Client 16 both the keys table, K_{P}, and the index-based OTP.

Shown in FIG. 5B is one embodiment of the Consumption Phase of my Indexed Sequencing Process, to be performed each time Client 16 desires to transmit a packet to Server 12. As can be seen, in the Consumption Phase of my Indexed Sequencing Process, I use the “first” index, Iₙ, in the OTP to control the selection of the key Kₙ in key table K. Both Client 16 and Server 12 then consume the now-used index from the local copies of the OTP.

My Indexed Sequencing Process may be re-executed at any time following boot. In particular, when the number of remaining indexes in the local OTP falls below a selected threshold, Server 12 can re-execute the Initialization Phase to generate a new OTP for ssh transmission to Client 16 shortly before, or contemporaneous with, the mutual exhaustion of the previous OTP. Again, just as in a traditional paper OTP process, each index comprising my electronic OTP is used once and only once.

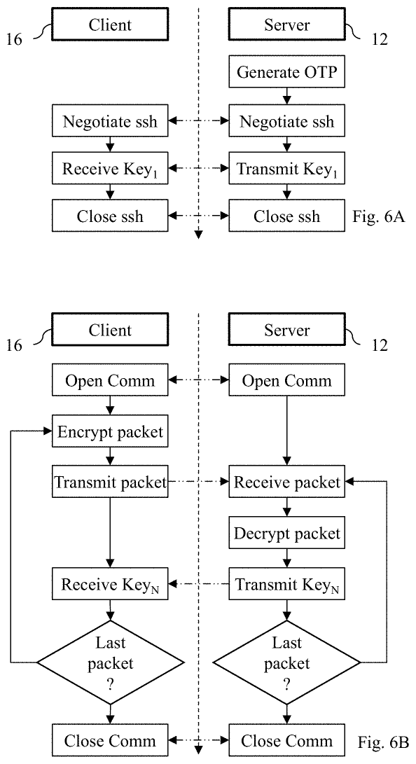

Shown in FIG. 6A is one embodiment of the Initialization Phase of my Explicit Sequencing Process, to be first executed during system boot. Similar to the Initialization Phase of my Implicit Sequencing Process, Server 12 generates an OTP, comprising an enumerated plurality, Z, of either asymmetric key_pairs, Z^{P} and Z_{P}, or symmetric keys, Z_{S}. However, in this embodiment, Server 12 does not transmit the full OTP to Client 16. Instead, Server 12 randomly selects the index one of the keys, Key_{N}, in the OTP using the following PHP code snippet:

<?php
// Randomly select a new symmetric key
$iMaxIndicies = 1024; // total number of indicies in OTP
$bOK = false;
do
{

$iIndex = mt_rand (1, $iMaxIndicies )]; // generate a new index
if (Encryption::_indexExists($iIndex )) // accept if still in OTP
{

Encryption::deleteIndex($iIndex ) // delete index
$bOK = true; // exit do loop

}

} while (!$bOK)
?>

This first key, let's call it Key₁, is then transmitted by Server 12 to Client 16. In this embodiment, both Server 12 and Client 16 are configured to use this key to encrypt/decrypt the first packet of the next message. Now, as I have illustrated in FIG. 6B, upon successfully decrypting a first received packet using Key₁, Server 12 will randomly select the next key, Key₂, and transmit it to Client 16. By way of example, let us assume that the Comm channel complies with the well known Transmission Control Protocol/Internet Protocol (“TCP/IP”) protocol suite. In accordance with this Protocol, the TCP header can be configured, inter alia, to convey to Client 16 an Acknowledgement (“ACK”) signal from Server 12. In addition, such an ACK signal may be configured to include an Options field of variable width. It is here that I propose to insert the next key, Key_{N}. In particular, I will configure Server 12 to encrypt each Key_{N+i} using the immediately preceding Key_{N}. Further, I will configure Client 16 to use the current key, Key_{N}, to recover the next key, Key_{N+1}, from each sequential ACK transaction. Thus, as can be seen, my Explicit Sequencing Process provides end-to-end secure transmission not only of data packets but also of the explicit sequence of keys, both using the basic principle of the OTP protocol.

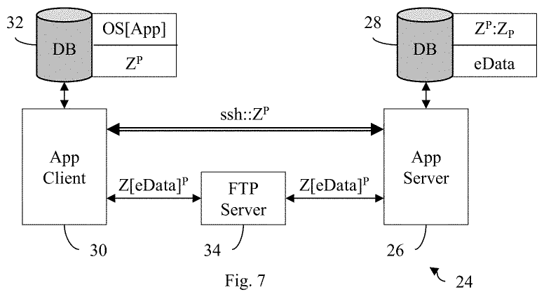

In FIG. 7, I have illustrated what I characterize as an Indirect Communication System (“ICS”) 24. In particular, I have configured this embodiment to support any generic App Server 26, having a local DB 28, and App Client 30, having a local DB 32. By way of example, I have configured my ICS 24 easily to support, inter alia, email service, web browsing, or any other application that relies, in whole or in part, on message traffic transiting a public communication network, such as the Internet. In the illustrated embodiment, I have configured my ICS 24 to practice my Implicit Sequencing Process, as I have described above. However, in my ICS 24, I have interposed an anonymous File Transfer Protocol (“FTP”) Server 34 between Server 26 and Client 30. Since all electronic data (“eData”) transiting the public Comm channel is fully encrypted using the pre-agreed sequence of public keys, Z^{P}, all such traffic is fully secured in accordance with the OTP principle. Of course, I could just as easily configure my ICS 24 to use symmetric keys rather than asymmetric key-pairs, as I have explained above. Further, I could also configure the FTP Server 34 to support bi-directional traffic, thereby providing a secure channel whereby Server 26 and Client 30 can be configured to practice either my Direct Sequencing Process or my Explicit Sequencing Process, both as explained above. For example, in the case of Explicit Sequencing, the receiving Server 26 or Client 30 could return to the transmitting Client 30 or Server 26, respectively, the next key/index via a reverse FTP transaction. In one further embodiment, I could configure my FTP Server 34 to instantiate any of my Sequencing processes, and thereby to control, via the ssh channel, the encryption/decryption processes performed within Servers 26 and Client 30.

As I have illustrated in my indirect system in FIG. 7, it is possible to configure any of my Sequencing Processes such that the Initialization Phase thereof is instantiated in any of Server 12/Client 16 or Server 26/Client 30. In a general form of my Consumption Phases, control of sequencing, if not implicit, can be instantiated in any of the several facilities comprising the end-to-end pathway. Indeed, the facility that controls sequencing can be different from the facility that selectively generates and pre-shares the OTP. Further, this sequencing control facility itself need not be in the direct data transfer path, so long as it is in the transaction control path.

Consider one interesting embodiment wherein the OTP is generated dynamically rather than statically as in the several configurations I have discussed above. Let us assume, by way of example, that Client 16 is configured to control both OTP generation and sharing, and consumption sequencing. In the Initialization Phase of this embodiment, Client 16 will generate only a single, first key, Key₁, and then securely share it with Server 12 using either ssh or an earlier-established OTP-based channel. As per usual, upon opening the non-secure, public Comm channel, Client 16 will consume Key₁ to encrypt the first packet. However, before doing so, Client 16 generates a second key, Key₂, and adds it to the packet at a pre-agreed location within the packet frame. Upon receipt and decryption using Key₁, Server 12 is able to recover Key₂ for use with the next packet. When the last packet, N, of a particular message has been successfully transmitted, the last pre-shared key, Key_{N}, will be retained by both Servers 12 and Client 16 for use with the first packet of the next message. Thus, in this way, the OTP is both generated and consumed on-the-fly, i.e., dynamically.

It is also possible in such an embodiment, during the Initialization Phase, to generate and securely pre-share an initial first-in-first-out stack comprising, say, K, keys. Then, as each packet is processed during the Consumption Phase, the key at the top of the stack will be popped off the stack, i.e., consumed, and the dynamically generated key will be pushed onto the bottom of the stack. I characterize this embodiment as a K-lookahead configuration, in that each dynamically generated key is associated with the Kth next packet.

In general, my OTP cryptography methods share the following characteristics:
1. During the reiterative Initialization Phase, a key set comprising one or more good keys is generated and securely pre-shared with all interested facilities.
2. During the reiterative Consumption Phase, the elements comprising the OTP are consumed in accordance with a predetermined, secure sequencing mechanism.
3. OTP consumption is on a packet-by-packet basis, i.e., each separate, discrete transmission transaction on the non-secure channel instantiated on the public communication network is protected using a different key than all other packets comprising a single message.

Some important features of my Sequencing Processes include:
1. Each key in a particular key set is selected in accordance with accepted cryptographic practices.
2. Pre-sharing can employ any secure channel, including ssh and an existing OTP-protected channel.
3. Sequencing control can be implicit, direct, explicit, indexed or indirect, or, in some effective combination thereof
4. Sequencing control can be substantially independent of transmission control.

Although I have described my invention in the context of particular embodiments, one of ordinary skill in this art will readily realize that many modifications may be made in such embodiments to adapt either to specific implementations. Thus it is apparent that I have provided several embodiments of one time pad methods that are both effective and efficient. Further, I submit that my methods and apparatus provide performance generally superior to the best prior art techniques.

In the appended claims, I intend the term computational facility to comprise any computer-based or processor-based processing facility or programmable electronic processing system that is either configured or configurable to perform the several functions I have discussed above in the context of my Server 12, Client 16, Server 26 and Client 30. I also intend that the terms “encrypt” and “decrypt” include any encryption methodology now known or hereafter developed that satisfies the criteria I have enumerated above with respect to my several sequencing processes. As will be clear to those skilled in this art, all of my sequencing processes can readily be instantiated in special-purpose electronic circuits, i.e., hardware or firmware or a combination of both, or in a programmed sequence of computer executable instructions, i.e., software, stored on a non-transient computer readable medium for execution on a general-purpose processor, or any functional combination thereof.

What I claim is:

1. A one time pad (OTP) cryptography method adapted for use in a public communication system comprising:
[1.0.1] a public communication network;
[1.0.2] a first communication facility adapted to be selectively coupled to the public communication network; and
[1.0.2] a second communication facility adapted to be selectively coupled to the public communication network; and
the method comprising the steps of:
[1.1] in a selected one of the first and second communication facilities, developing a OTP comprising at least a first key;
[1.2] using a secure channel instantiated on the public communication network to pre-share the OTP with the first and second communication facilities;
[1.3] in the first communication facility:
[1.3.1] using the first key to encrypt a first packet of a first message comprising a plurality of packets; and
[1.3.2] transmitting the encrypted first packet via a non-secure channel instantiated on the public communication network;
[1.4] in the second communication facility:
[1.4.1] receiving the encrypted first packet via the non-secure channel; and
[1.4.2] using the first key to decrypt the encrypted first packet; and
[1.5] in the first and second communication facilities, consuming the first key.

2. The method of claim 1:
wherein the OTP is further characterized as comprising first and second keys; and
wherein, upon consuming the first key in the OTP, the second key becomes the first key;
further comprising the steps of:
[1.6] in the first communication facility:
[1.6.1] encrypting a next packet of the first message using the first key; and
[1.6.2] transmitting the encrypted next packet via the non-secure channel instantiated on the public communication network;
[1.7] in the second communication facility:
[1.7.1] receiving the encrypted next packet via the non-secure channel; and
[1.7.2] decrypting the encrypted next packet using the first key; and
[1.8] in the first and second communication facilities, consuming the first key.

3. The method of claim 2:
wherein the OTP is further characterized as comprising a plurality, n, of keys; further comprising the step of:
[1.9] repeating steps [1.6] through [1.8] for each of n packets of the first message.

4. In a system comprising:
[4.0.1] a public communication network;
[4.0.2] a first computational facility selectively coupled to the communication network; and
[4.0.2] a second computational facility selectively coupled to the communication network; and
a one time pad (OTP) cryptography method comprising:
[4.1] an OTP initialization phase comprising the steps of:
[4.1.1] in a selected one of the first and second computational facilities, generating an OTP comprising a first random key and a second random key;
[4.1.2] opening a secure communication channel between the selected computational facility and the non-selected computational facility via the public communication network;
[4.1.3] selectively transmitting the OTP from the selected computational facility to the non-selected computational facility via the secure communication channel; and
[4.1.4] closing the secure communication channel; and
[4.2] an OTP consumption phase comprising the steps of:
[4.2.1] opening a non-secure communication channel between the first and second computational facilities via the public communication network;
[4.2.2] in the first and second computational facility, selecting the first random key from the OTP;
[4.2.3] in the first computational facility, using the selected first random key to encrypt a first packet of a first message
[4.2.4] in the first computational facility, transmitting the encrypted first packet to the second computational facility;
[4.2.5] in the second computational facility, receiving the encrypted first packet from the first computational facility;
[4.2.6] in the second computational facility, using the selected first random key to decrypt the received encrypted first packet;
[4.2.7] in the first and second computational facilities, consuming the first random key from the OTP whereby the second random key is now the first random key in the OTP;
[4.2.8] if the transmitted packet is not the last packet of the first message, repeating steps [4.2.2] through [4.2.7]; and, otherwise,
[4.2.9] closing the non-secure communication channel.

5. A communication system configured to practice the method of any preceding claim.

6. A non-transitory computer readable medium including executable instructions which, when executed in a processing system, causes the processing system to perform the steps of a method according to any one of claims 1 to 4.
